(19) United States
(12) Patent Application Publication
(10) Pub. No.: US 2018/0310581 A1
(43) Pub. Date: Nov. 1, 2018

(54) SYSTEM, METHOD AND APPARATUS FOR INDIRECT ELECTROMAGNETIC IRRADIATION OF LIQUID AND GASEOUS MEDIUMS

(71) Applicant: Johann Kreutzinger, Rehetobel (CH)

(72) Inventor: Johann Kreutzinger, Rehetobel (CH)

(21) Appl. No.: 15/960,065

(22) Filed: Apr. 23, 2018

Related U.S. Application Data
(60) Provisional application No. 62/490,521, filed on Apr. 26, 2017.

(51) Int. Cl. A23C 3/07; C12H 1/16; A23L 3/28

(52) U.S. Cl. CPC A23C 3/076; A23V 2002/00; A23L 3/28; C12H 1/165

(57) ABSTRACT

This disclosure relates generally to a system, method and apparatus for the indirect electromagnetic irradiation of liquid and gaseous mediums. More specifically, this disclosure relates to a method of using a high intensity ultraviolet emitting light source that enables a high flux of selected wavelengths of far ultraviolet electromagnetic radiation to impinge on a chosen medium while simultaneously reducing or preventing exposure of said medium to undesirable heat (infrared) and other visible and near ultraviolet wavelengths. More specifically, this disclosure relates to a system and method of employing an apparatus with one or more parabolic reflectors, mirrors and/or other light focusing, filtering and redirecting means to expose a medium flowing within a UV transmitting medium transport tube to a desired wavelength or range of desired wavelengths of far ultraviolet electromagnetic radiation for the purpose of irradiating a chosen liquid and/or gaseous medium.

### BACKGROUND

### Priority

This application claims the benefit of U.S. Patent application 62/490,521 filed Apr. 26, 2017 by the same inventor which is include by reference as if fully set forth herein.

### SUMMARY OF INVENTION

This disclosure relates generally to a system, method and apparatus for the indirect electromagnetic irradiation of liquid and gaseous mediums. More specifically, the disclosure relates to a method of using a high-intensity, ultraviolet-emitting light source that enables a flux of selected wavelengths or range of ultraviolet electromagnetic radiation to impinge on a chosen medium while simultaneously reducing or preventing exposure of said medium to undesirable heat (infrared) and other visible and near ultraviolet wavelengths. More specifically, the disclosure relates to a system and method of employing an apparatus with one or more parabolic reflectors, mirrors and/or other light focusing, filtering and redirecting means to expose a medium flowing within a UV transmitting medium transport tube to a desired wavelength or range of desired wavelengths of ultraviolet electromagnetic radiation for the purpose of irradiating a chosen liquid and/or gaseous medium.

### DETAILED DESCRIPTION

### Generality of The Disclosure

This application should be read in the most general possible form. This includes, without limitation, the following:

References to specific techniques include alternative and more general techniques, especially when discussing aspects of the disclosure, or how the embodiment might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### BRIEF DESCRIPTION OF DRAWINGS

FIG. 1A illustrates ray tracing of an optical system used in indirect irradiation, according to embodiments of the disclosure;

FIG. 1B illustrates exemplary treatment tube transmission data, according to embodiments of the disclosure.

FIG. 1C illustrates an exemplary optical bandpass filter, according to embodiments of the disclosure;

FIG. 1D illustrates exemplary light source data, according to embodiments of the disclosure;

FIG. 2 illustrates a medium physical treatment system, according to embodiments of the disclosure;

FIG. 3A illustrates a method of indirect irradiation, according to embodiments of the disclosure;

FIG. 3B illustrates a method of indirect irradiation, according to embodiments of the disclosure;

FIG. 4A illustrates an exemplary chemical reactions, according to embodiments of the disclosure;

FIG. 4B illustrates tannin content and taste test graph data, according to embodiments of the disclosure;

FIG. 5A illustrates an absorption band for oxygen and color intensity changes after treatment, according to embodiments of the disclosure;

FIG. 5B illustrates oxygen concentration without and with the use of embodiments described herein according to embodiments of the disclosure; and,

FIG. 6A illustrates an agitator-diffuser indirect irradiation system, according to embodiments of the disclosure;

FIG. 6B illustrates a bench-top indirect irradiation system, according to embodiments of the disclosure; and

FIG. 6C illustrates a system for deploying an indirect irradiation system in a self-contained unit in a medium container, according to embodiments of the disclosure.

### PROCESSING SYSTEM

The methods and techniques described herein may be performed under the control of a processor-based device. The processor-based device will generally comprise a processor attached to one or more memory devices or other tools for processing input signals and data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor contemplates that the methods disclosed herein will also operate over a network such as the Internet, and may be effectuated using combinations of several processing devices, memories and I/O. Moreover any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), laptop, modem, notebook and tablet computing devices operating through wireless networks. These wireless devices may include a processor, memory coupled to the processor, displays, keypads, WiFi, Bluetooth, GPS and other I/O functionality. Alternatively, the entire processing system may be self-contained on a single device.

The methods and techniques described herein may be performed on a processor-based device. The processor-based device will generally comprise a processor attached to one or more memory devices or other tools for persisting data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touchscreens, displays, pocket pagers and terminals as well as remote connected computer systems, modems, radio transmitters and handheld personal communication devices such as cellular phones, “smart phones” and digital assistants.

The processing system may also include mass storage devices such as disk drives and flash memory modules as well as connections through I/O devices to servers containing additional storage devices and peripherals. Certain embodiments may employ multiple servers and data storage devices thus allowing for operation in a cloud or for operations drawing from multiple data sources. The inventors contemplate that the methods disclosed herein will operate over a network such as the Internet, and may be effectuated using combinations of several processing devices, memories and I/O.

The inventors further contemplate integration of embodiments of the present disclosure a network of nodes that are capable of performing some processing, gathering sensory information and communicating with other nodes in the network. Such wireless sensor nodes may include devices, vehicles, buildings and other items embedded with electronics, software, sensors, and network connectivity that enables the nodes to collect and exchange data (sometimes referred to as “Internet of Things” (IoT) or a wireless sensor network).

The processing system may be a wireless device such as a smart phone, personal digital assistant (PDA), laptop, modem, notebook and tablet computing devices operating through wireless networks. These wireless devices may include a processor, memory coupled to the processor, displays, keypads, WiFi, Bluetooth, GPS and other I/O functionality.

### DETAILED DESCRIPTION OF INVENTION

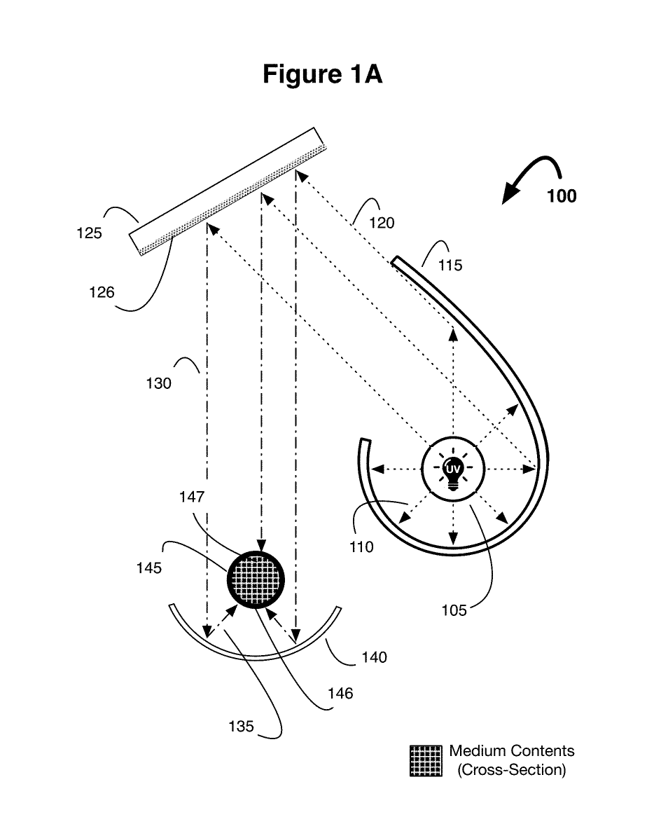

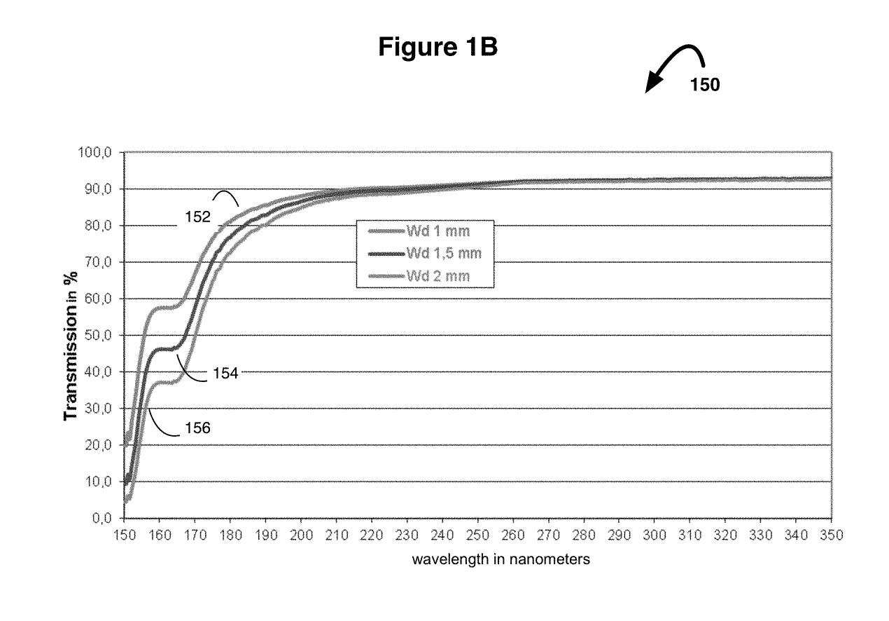

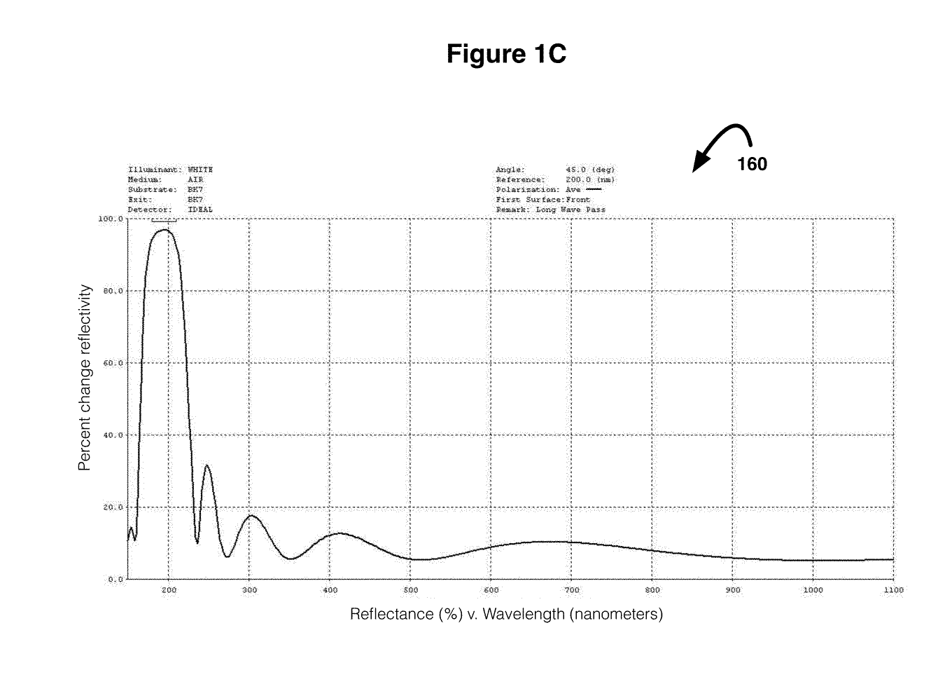

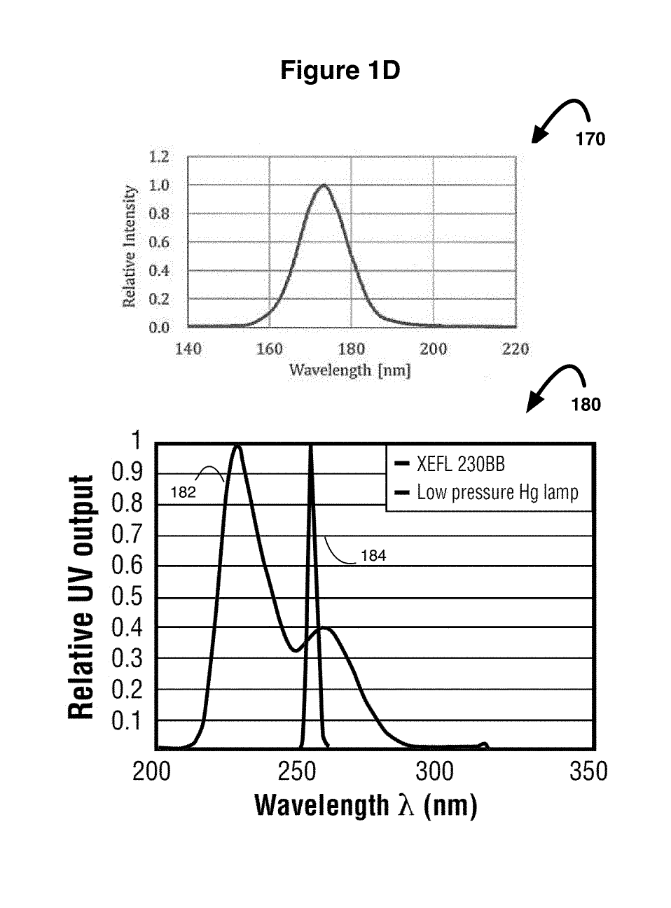

### FIGS. 1A, 1B 1C and 1D

FIG. 1A: raytracing in an Exemplary optical system

FIGS. 1A, 1B, 1C and 1D illustrate ray tracing of an optical system used in indirect irradiation and wavelength data, according to embodiments of the disclosure. Indirect irradiation systems as described herein may include a light source 105 that emits source illumination 110, as shown by the arrows emanating isotropically from light source 105. Light source 105 is illustrated cross-sectionally, representing the view that light source 105 projects orthogonally (normally) from the plane of the drawing, as viewed by the reader.

Elements in FIG. 1A are shown cross-sectionally in order to facilitate viewing. Medium contents inside medium transport tube 145 can be conceptualized as flowing normal to the page. Light 110 strikes source parabolic mirror 115, which may focus source illumination 110 as mirrored light 120. Mirrored light 120 may strike reflector 125 and may be reflected as reflected light 130. In some embodiments, source parabolic mirror 115 may completely collect, parallelize and focus mirrored light 120 toward reflector 125 and diffraction grating 126. In some embodiments, mirrored light 120 may be of a different wavelength than source illumination 110. In further embodiments, parabolic mirror 115 may or may not alter the wavelength of source illumination 110 using methods as described herein. In some embodiments, diffraction grating 126 may be an interference filter or bandpass filter.

Diffraction grating 126 denotes the front refractive surface of the reflector 125 and is denoted with a stippled texture. In some embodiments, any or all mirrors and/or reflectors described herein may be made of or surface-coated with gold, aluminum or platinum.

In some embodiments, reflector 125 may be a dichroic mirror. In further embodiments, reflector 125 may be a dichroic mirror that may be joined to or combined with an optical bandpass filter as described herein. In these embodiments, this optical bandpass filter may be capable of selecting the wavelength range of reflected light 130. In other embodiments, this optical bandpass filter may filter out any and all other undesired wavelengths of light, which may exclude, by way of example and not limitation, 160 nm to 300 nm. In further embodiments, diffraction grating 126 may assist in this process. In another embodiment, this optical bandpass filter may allow UV light wavelengths of approximately 265 nm.

It is important to note that light waves 120 and 130 are representative of one or more light waves being reflected from source parabolic mirror 115 and reflector 125. While a finite number of light waves (e.g., light waves 120, 130) may be illustrated in the figure, it is known in the art that light has the distinct characteristic of being both a wave and a particle. Thus one or more light waves are chosen as being representative of a multitude of light waves not shown. Furthermore, incidence and reflection/refraction angles of the light waves as shown are approximated in FIG. 1 to follow Bragg's Law.

Reflected light 130 may be shed onto medium transport parabolic mirror 140. Reflected light 130 may be redirected from medium transport parabolic mirror 140 as mirrored light 135. Mirrored light 135 may be shed onto medium transport tube 145. Similar to light source 105, medium transport tube 145 is shown cross-sectionally, thus the viewer observes a cross section of medium transport tube 145 and contents 147, illustrated in FIG. 1 as a walled-circle and a cross-hatched inner circle, respectively. Medium contents inside medium transport tube 145 can be conceptualized as flowing normal to the page.

Finally, diffraction grating 126 redirects mirrored light 120 at a selected Bragg angle or angle of diffraction. In this manner, diffraction grating 126 reflects said light (now in the form of redirected light 130) onto medium transport parabolic reflector 140. Note that reflected light 130 may have different wavelength characteristics from mirrored light 120 due to the effects of diffraction grating 126.

In some embodiments, medium transport parabolic mirror 140 may focus mirrored light 135 radially onto medium transport tube 145. In these embodiments, ‘radially’ refers to the possibility that mirrored light 135 may be approximately evenly distributed onto medium transport tube 145 and tube wall 146, thus uniformly irradiating medium transport tube 145 and contents 147 of medium transport tube 145. In further embodiments, contents 147 may be liquid or gaseous mediums such as, by way of example and not limitation, wine, alcoholic spirits, olive oil or milk. In these embodiments, contents 147 may be visualized as traveling through medium transport tube 145 in a direction normal to FIG. 1 (i.e., orthogonally into or out of the plane of the illustration).

In some embodiments, source parabolic mirror 115 may completely collect and focus source illumination 110 away from medium transport tube 145. In these embodiments, only certain select wavelengths within source light 105 may make the final journey to medium transport tube 145. Further still in these embodiments, heat impingement onto medium transport tube 145 from light source 110 may be minimized. In other embodiments, a cooling system (e.g., fan or heat sink, or other means known in the art) (not shown) may be employed to cool the contents of medium transport tube 145 and/or light source 105.

In one embodiment, medium transport tube 145 may be removable. In further embodiments, indirect irradiation systems as described herein may be miniaturized as a bench-top system, dolly-wheeled system or self-contained unit that can be transported as described herein.

### FIG. 1B: Treatment Tube Transmission Data

FIG. 1B illustrates exemplary treatment tube transmission data, according to embodiments of the disclosure. Graph 150 illustrates transmission percentage (Y-axis) versus wavelengths of light (X-axis) transmitted through quartz glass test tubes of varying widths of quartz glass.

In some embodiments, medium transport tube 145 may be composed at least partly of quartz glass. In further embodiments, the use of a synthetic quartz glass allows for the transmission of certain wavelengths of UV, by way of example and not limitation, 160 nm to 300 nm. In some tests, ILMASIL PS quartz glass manufactured by QSIL(TM) was used.

As shown in Graph 150, line Wd 1 mm 152 is a quartz glass test tube with a 1 mm wall thickness, Line Wd 1.5 mm 154 is a quartz glass test tube with a 1.5 mm wall thickness, and Line Wd 2 mm 156 is a quartz glass test tube with a 2 mm wall thickness as tested.

In further embodiments, the use of a cylindrical tube shape may allow for more uniform irradiation of the medium to be treated. By way of example and not limitation, an exemplary set of specifications for a medium transport tube is provided in Table 1.1, below.

TABLE 1.1
Exemplary Treatment Tube Specifications

| | | |
|---|---|---|
| Medium transport tube internal diameter | 27 | mm |
| Medium transport tube length | 750 | mm |
| Medium transport tube volume | 0.43 | liters |
| Medium flow rate | 500 | liters/hour |

### FIGS. 1C and 1D: Exemplary Light Source Data

FIGS. 1C and 1D illustrate exemplary light source data, according to embodiments of the disclosure. In some embodiments, light source 105 may be, by way of example and not limitation, a linear medium-pressure mercury lamp, an excimer light source or LED, or any known light source. In further embodiments, source illumination 110 emitted by light source 105 may be ultraviolet light in the range of 160-300 nm. In still other embodiments, source illumination 110 may be emitted by light source 105 as broad spectrum light. More details on light source 105 and source illumination 110 may be found as described herein.

In one embodiment, an excimer light source such as a VUV 172 nm light source may be used in conjunction with phosphoring to produce desired wavelengths as described herein. In testing, an USHIO (TM) ExciJet172 and PureRelease was used and provided UV light at suitable wavelengths as described herein. Additionally, in testing, light sources described herein had varying germicidal effects on tested mediums. Peak germicidal effectiveness occurred when medium contents were exposed to UV light with wavelengths of approximately 265 nm using embodiments described herein.

FIG. 1C shows an exemplary optical bandpass filter 160 suitable for some embodiments described herein. The percent change in reflectivity (Y-axis) is plotted against wavelength in nanometers (X-axis). In one embodiment, synthetic quartz glass provided superior irradiation when treating medium contents (by way of example and not limitation, wine). In testing, synthetic quartz encompassed a short range of UV wavelengths suitable for irradiation as described herein.

FIG. 1D shows graph data for exemplary light source outputs before and after phosphoring. In some embodiments, excimer lamps output wavelengths of 176 nm, as shown in Graph 170. This wavelength may not be suitable for some embodiments described herein, however, with phosphoring, wavelengths suitable to embodiments described herein may be achieved, as shown in Graph 180. In Graph 180, relative intensity, with a relative maximum of 1 (Y-axis) is plotted against on wavelength in nanometers (X-axis).

Graph 180 shows a graph of relative UV output in percent (Y-axis) versus UV wavelength in nanometers (X-axis) of three light sources. Graph 180 shows the performance in testing of XEFL230BB is shown as data line 182, and Low Pressure Hg Lamp is shown as data line 184.

The above illustrations provide many different embodiments or embodiments for implementing different features of the invention. Specific embodiments of components and processes are described to help clarify the invention. These are, of course, merely embodiments and are not intended to limit the invention from that described in the claims.

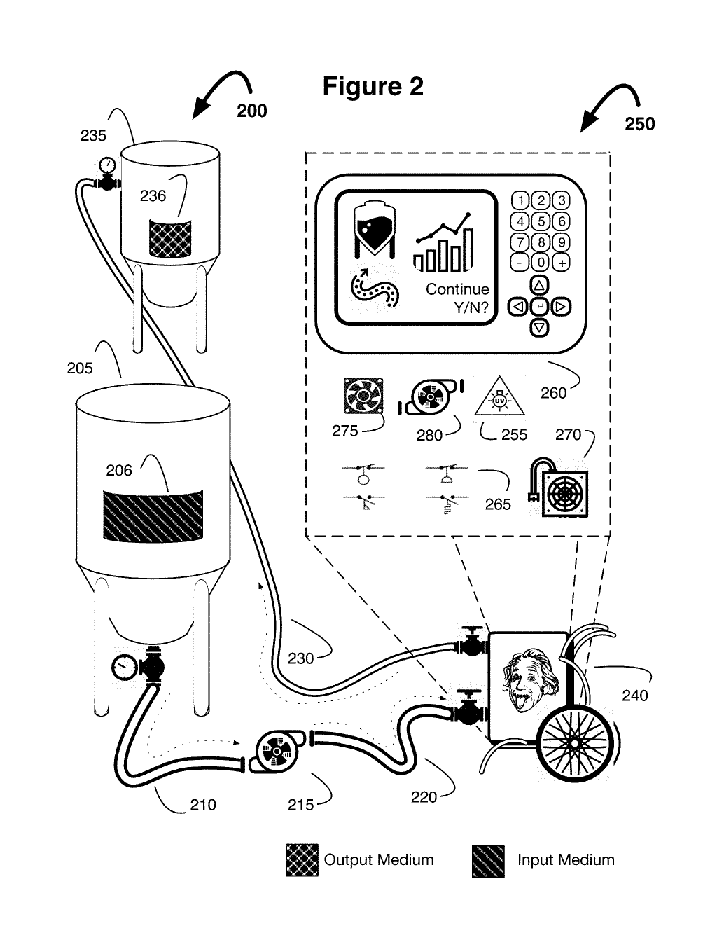

### FIG. 2: Exemplary Medium Physical Treatment System

FIG. 2 illustrates a medium physical treatment system, according to embodiments of the invention. Pretreatment storage tank 205 may contain pretreatment medium contents 206, shown as a shaded portion of pretreatment storage tank 205. In some embodiments, pretreatment medium contents 206 and medium contents generally, may be, by way of example and not limitation, a liquid or gas, such as wine, olive oil or milk or any flowable medium to be irradiated. Pretreatment medium contents 206 may flow into first stage input pipe 210. In some embodiments, an optional pump 215 controls the flow of pretreatment medium contents 206 into second stage input pipe 220. In some embodiments, neither optional pump 215 nor second stage input pipe 220 are required, and flow may be powered based on other pumps described herein.

In some embodiments, a flow meter (not shown) located near second stage input pipe 220 guides the flow rate of pretreatment medium contents 206 by controlling optional pump 215. Second stage input pipe 220 guides pretreatment medium contents 206 into radiation treatment system 240. In some embodiments, optional pump 215 and second stage input pipe 220 are contained within and/or controlled by radiation treatment system 240.

Radiation treatment system 240 is shown as exploded view 250 for the viewer's ease of observation. Radiation treatment system 240 includes, by way of example and not limitation, one or more of the following elements: optical indirect irradiation system 255, programmable logic controller with optional HMI (PLC) 260, medium contents sensor package 265, power supply 270, cooling system 275 and optional secondary pump 280. Optional secondary pump 280 may be included to provide fine-tuning of medium content flow, and is not included in some embodiments.

In some embodiments, optical indirect irradiation system 255 may include one or more elements as illustrated in FIG. 1. In these embodiments, optical indirect irradiation system 255 may treat pretreatment medium contents 206, causing a transformation of pretreatment medium contents 206 into post-treatment medium contents 236. Note that both pretreatment medium contents 206 and post-treatment medium contents 236 may be referred to simply as “medium contents generally.” The method of treatment and the specifications of post-treatment medium contents 236, the storage state of which is shown as a shaded portion of post-treatment storage tank 235, are described herein.

In some embodiments, PLC 260 may be programmed to control one or more of the following variables: pretreatment medium content flow rate, radiative intensity and/or radiation exposure time of radiation produced by optical indirect irradiation system 255, temperature of pretreatment medium contents 206, and recycling of medium contents generally as needed. More detailed treatment methodologies that may be programmed into PLC 260 are discussed herein. In some embodiments, only a single parameter need be adjusted, by way of example and not limitation this parameter may be treatment intensity or radiative intensity).

PLC 260 may incorporate processing system elements as described herein. While PLC 260 is shown with an HMI interface, the inventor contemplates any and all known methods of interfacing with a computer, including mobile apps on smart devices. In one embodiment, users of embodiments described herein may be able to control embodiments described herein using their mobile device with a controlling app that may control and monitor embodiments described herein, and update users with mobile notifications as known.

Medium contents sensor package 265 may include, by way of example and not limitation, one or more of the following (not shown): humidity sensor, flow rate sensor (e.g., electromagnetic, paddle-wheel style or any other known flow rate sensor), electromagnetic radiation failure sensor, thermometer, turbulence/Reynolds number sensor, cavitation sensor, oxygen sensor, oximeter, pH sensor, ultrasonic sensor, and photoelectric light sensor. In addition, cooling system 275 may consist of one or more fans (e.g., standard rotary, blade, squirrel, radial and axial fans), liquid water cooling, liquid nitrogen cooling, refrigeration/air condition system, compressor (e.g., Freon (TM)), or any other known cooling system.

Pretreatment medium contents 206 may be transformed into post-treatment medium contents 236 in a treatment tube (not shown). In some embodiments, the treatment tube may be similar to medium transport tubes as described herein. It is worth noting that flow through the treatment tube may be laminar or turbulent. In some embodiments, such turbulence may desirable, in that turbulence of the medium may cause greater depth of radiative penetration, thus allowing for more uniform irradiation of the medium and thus more even treatment of medium contents generally. This may be especially important in the case of ultraviolet radiation. Despite the high-energy nature of UV radiation, the radiative penetration power of this light may be limited due to the inherently short wavelength of W. Thus, in one embodiment, turbulence of the medium in the form of a Reynolds number of less than 2300 may be desirable. In other embodiments, cavitation within the medium is not desirable and is to be avoided.

In some embodiments, pump 280 may function to control the flow of medium contents generally through the treatment tube or radiation treatment system 240 generally. In other embodiments, medium contents sensor package 265 may include a flow sensor (not shown) that controls pump 280 thereby guiding the flow of medium contents generally through the treatment tube or radiation treatment system 240 generally.

Post-treatment medium contents 236 may be metered through output pipe 230. Output pipe 230 feeds post-treatment medium contents 236 into post-treatment storage tank 235. Post-treatment medium contents 236 is shown as a cross-hatched portion of post-treatment storage tank 235, but is created through processes described herein within radiation treatment system 240.

In an optional embodiment, a sample of the post-treatment contents 236 may be extracted for examination by an operator of the embodiments of the invention or an expert. In this embodiment, a system for determining an operating point for radiation treatment system 240 also allows for adjustment of medium physical treatment system 200 to suit personal preferences of said operator. In one embodiment, the operating point may be the treatment intensity of medium contents generally as medium contents generally flow through radiation treatment system 240. In some embodiments, the treatment intensity may be the inverse of the flow rate of medium contents generally as medium contents generally flow through radiation treatment system 240. In other embodiments, the operating point may be a selected set of operational parameters used to define the treatment conditions applied to a particular medium. These parameters may be chosen to achieve any desired end properties in the treated medium following processing. These operational parameters may include by way of example and not limitation, one or more of the following: radiation intensity, radiation exposure time, flow rate.

In one embodiment, a “taste test” mode using a test sample container may be employed. In this embodiment, a test sample container, preferably made of UV-permeable quartz glass, may be used. This test sample container may be filled with medium contents generally, introduced into the beam path, irradiated for a period of time and then tasted by an expert. This process is repeated with different exposure times, for example, three to four times until the optimal properties of the medium may be reached, as determined by the expert. Thereafter, a method for reaching the optimal properties may be determined via a table or automatically via a programmed algorithm. In one embodiment, the programmed algorithm may include a selected treatment intensity of the medium that may be proportional to the exposure time, which may be inverse to the flow rate of the medium, as guided by the results of the taste test mode.

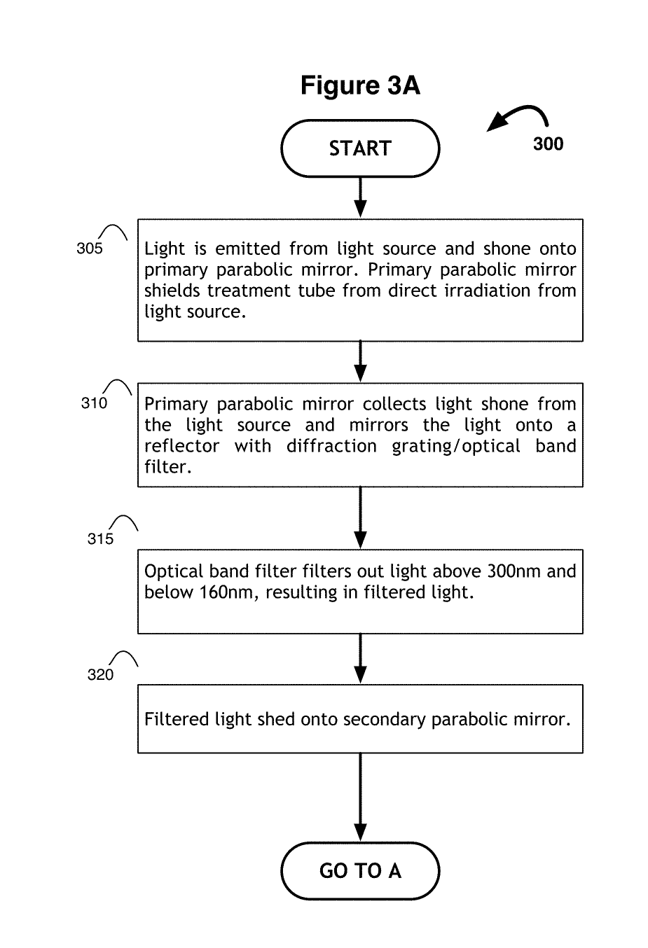

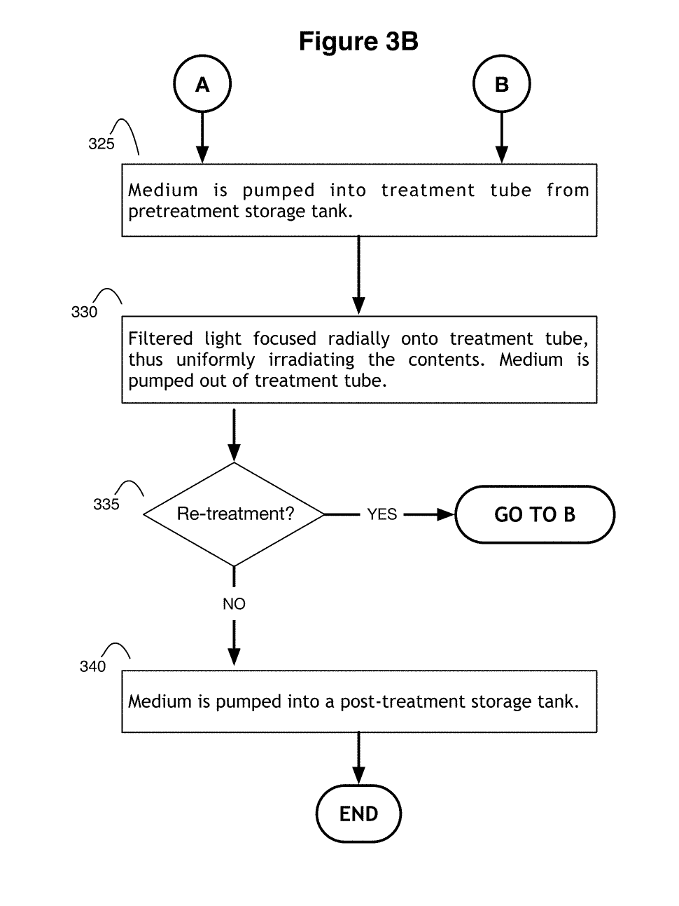

### FIGS. 3A and 3B: Exemplary Method of Indirect Irradiation

FIGS. 3A and 3B illustrate a method of indirect irradiation, according to embodiments of the invention. Although the method steps are described in conjunction with FIGS. 1-6, persons skilled in the art will understand that any system configured to perform the method steps, in any order, falls within the scope of the present invention. The steps in this method are illustrative only and do not necessary need to be performed in the given order they are presented herein. Some steps may be omitted completely. In some embodiments, elements of the method 300 may be loaded into a programmable logic controller such as PLC 260.

The method 300 begins with a step 305, in which light is emitted from a light source and directed onto a primary parabolic mirror. In some embodiments, the primary parabolic mirror shields a treatment tube from direct irradiation from the light source in this step.

At a step 310, the primary parabolic mirror collects light shone from the light source and mirrors the light onto a reflector. In some embodiments, the reflector may contain an optical band filter or diffraction grating. In some embodiments, this mirror may be a dichroic mirror. At a step 315, the optical band filter filters out unwanted light In some embodiments, this unwanted light is in the wavelength range above 300 nm and below 160 nm. In other embodiments additional unwanted light is in the wavelength range 230-260 nm or similar. Thus, in one embodiment, this step results in the reflector reflecting the desired frequencies of light. At a step 320, the filtered light is shed onto a secondary parabolic mirror.

At a step 325, a medium is pumped into a treatment tube. In some embodiments, the treatment tube may contain liquid or gaseous mediums such as, by way of example and not limitation, wine, olive oil, alcoholic spirits or milk. In some embodiments, the flow rate (e.g., rate of liquid volume or weight transfer through the treatment tube) is controlled through a metering pump. It should be noted that, in one embodiment, the treatment intensity of the medium is the inverse of the flow rate through the indirect irradiation system. The flow rate parameter may be adjusted by the user (e.g., a taste expert). In the case of alcoholic beverages such as wine, the flow rate parameter may be adjusted by an expert wine taster based on grape variety, year of grape production and terroir, as well as other attributes of the medium. The expert may enter the parameter into a PLC, and the PLC calculates the proper flow rate of the medium thus controlling the metering pump with the calculated parameters.

At a step 330, the secondary parabolic mirror reflects filtered light onto the treatment tube. In this step, the secondary parabolic mirror focuses filtered light radially onto the treatment tube. In this manner, filtered light may be evenly distributed onto the treatment tube, thus uniformly irradiating the contents of the treatment tube. At a step 335, after the medium has been treated in the treatment tube, the medium is pumped out of the treatment tube. In some embodiments, the medium is irradiated while flowing through the treatment tube without stopping. In some embodiments, the medium may be pumped back into the treatment tube for repeated irradiation. At a step 340, the medium is pumped into a post-treatment storage tank, after which the method 300 ends.

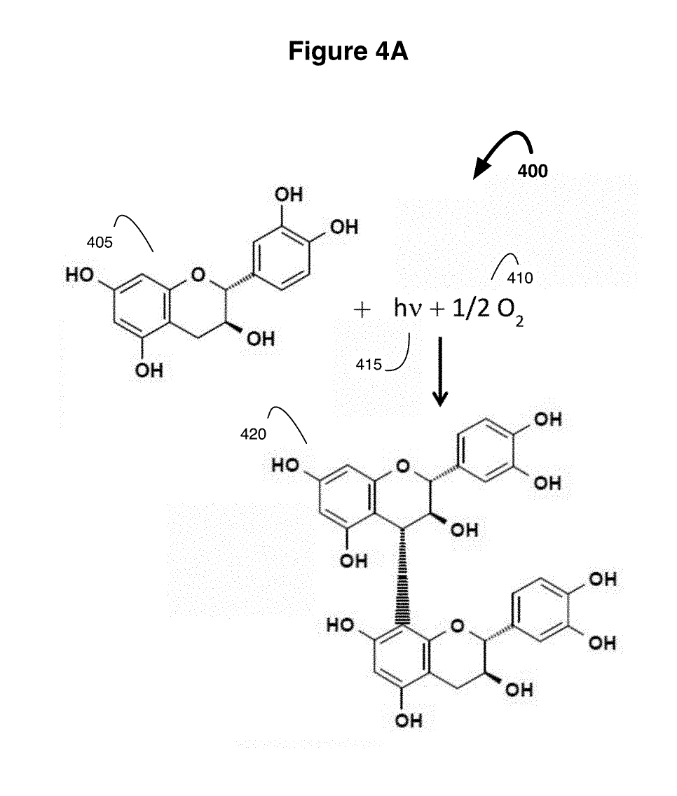

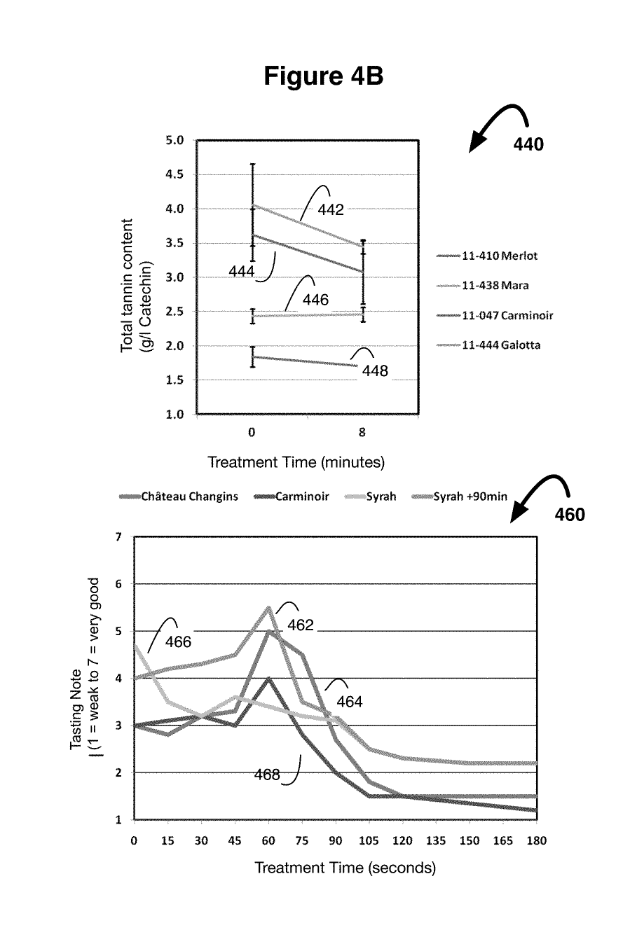

### FIGS. 4A and 4B: Exemplary Chemical Data

### FIG. 4A: Chemical Reactions

FIG. 4A illustrates an exemplary chemical reactions, according to embodiments of the disclosure. Chemical reaction 400 may be induced upon by embodiments of the invention, by way of example and not limitation, indirect irradiation systems as described herein. Chemical reaction 400 may explain part of the reactions and chemical processes disclosed herein.

In one embodiment, chemical reaction 400 details the effect of indirect irradiation systems as described herein upon an alcoholic beverage (by way of example and not limitation, wine). In further embodiments alcoholic beverages may contain un-condensed tannins, flavonoids or polyphenols that cause the alcoholic beverage to be sour, bitter, or otherwise unpleasant to drink.

In still further embodiments, alcoholic beverages may contain an amount of dissolved oxygen, present either as molecular oxygen (O₂) or ozone. In yet further embodiments, enough oxygen may be naturally present within the alcoholic beverage for the irradiation process to begin polymerizing and/or rearranging the tannins or flavonoids, as described herein. Advantageously, exogenous oxygen need not be loaded into the medium for this condensation process to occur.

In one embodiment, chemical 405 may represent a tannin or flavonoid. Note, in some embodiments, multiple qualities of chemical 405 may be required (e.g., 2). When embodiments of the invention (e.g., indirect irradiation systems as described herein or radiation treatment system 240) irradiate chemical 405 as well as dissolved oxygen (shown by way of example and not limitation, oxygen 410), the dissolved oxygen may dissociate. This dissociation is due to irradiation from, by way of example and not limitation, UV within the range of 160 to 300 nm, or vacuum-UV. In one embodiment, high-energy photon 415 may cause the dissociation of oxygen. In a further embodiment, high-energy photon 415 may be UV within the range of 160 to 300 nm, or vacuum-UV.

In another embodiment, high-energy photon 415 may cause the formation of a cross-linking bond between chemical 405 and another chemical 405, resulting in polymer 420. In this manner, indirect irradiation systems as described herein causes flavonoids or tannins to polymerize. This may result in improved flavor or tannin profile of the irradiated wine. Advantageously, such an improved flavor or tanning profile may be achieved with a reduced maturation time when compared to barrel maturation as known in the art. In this manner, the irradiated wine may be more pleasant or smoother to drink.

FIG. 4B: Tannin Content & Tasting Notes after Treatment

FIG. 4B illustrates tannin content and taste test graph data, according to embodiments of the disclosure. Graph 440 shows total tannin content vs. treatment time of wine exposed to embodiments described herein. Graph 440 compares total tannin content measured in grams per liter of Catechin (Y-axis) versus treatment time in minutes (X-axis). The four wines tested were Gallotta 442, Carminoir 444, Mara 446, and Merlot 448. As shown, after wines were exposed to embodiments described herein, indirect irradiation systems as described herein may polymerize tannins in wines.

Graph 460 shows wine tasting notes versus treatment time of wine exposed to embodiments described herein. Graph 460 compares tasting notes (subjective impression) of four wines (Y-axis) versus treatment time in minutes (X-axis) using embodiments described herein. The four wines tested were: a Syrah +90 minutes 462, Chateau Changnins 464, Syrah 466, and Carminoir 468. In testing, Syrah +90 minutes refers to a bottle of Syrah that has been opened and exposed to air for 90 minutes, allowing the Syrah to absorb outside oxygen.

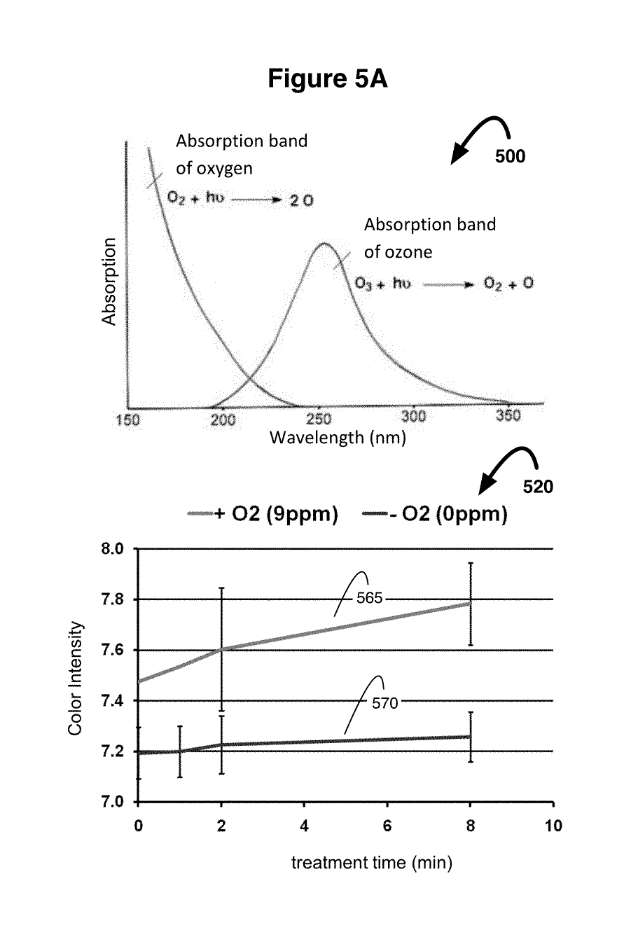

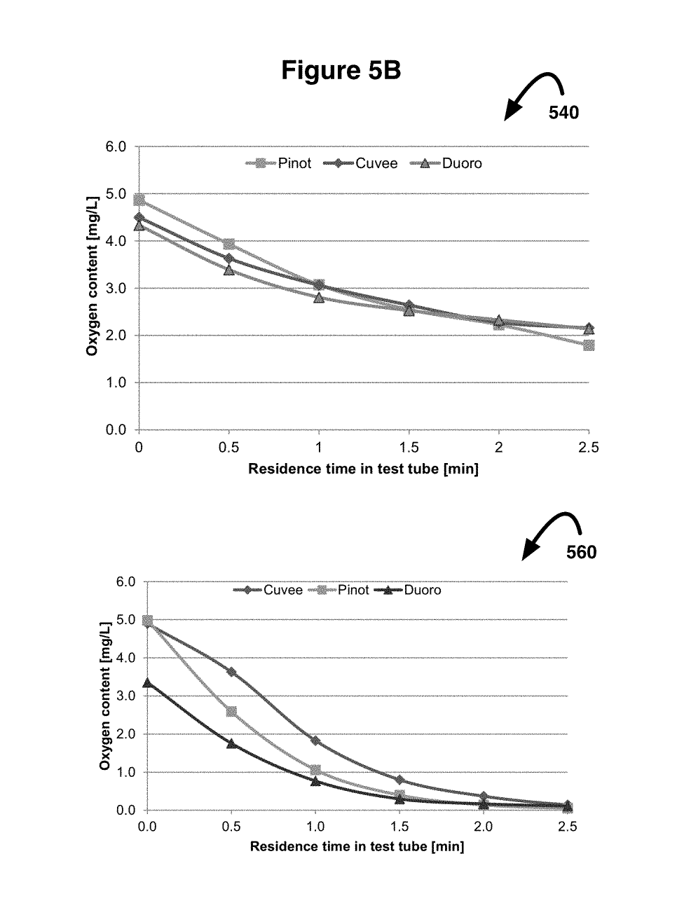

### FIGS. 5A and 5B: Oxygen Data

### FIG. 5A: Absorption Band for Oxygen and Ozone

FIG. 5A illustrates an absorption band for oxygen and color intensity changes after treatment, according to embodiments of the disclosure. Graph 500 illustrates an absorption band for oxygen and ozone. Graph 500 shows that the absorption band for oxygen for absorption of light peaks approximately around the 160 nm wavelength (i.e., vacuum-UV). Graph 500 also shows the absorption band for ozone occurs around the 250 nm wavelength.

In one embodiment, light source 105 that is employed in indirect irradiation systems as described herein includes a means to transmit extremely low wavelength ultraviolet (UV) radiation of between 120 nm to about 250 nm, or alternatively between 120 nm to about 225 nm, or yet alternatively between 120 nm to about 200 nm, or alternatively between 120 nm to about 180 nm. In other exemplary embodiments, light source 105 includes a means to transmit higher wavelength ultraviolet radiation of between 140 nm to about 350 nm, or alternatively between 160 nm to about 300 nm, or yet alternatively between 180 nm to about 275 nm, or alternatively between about 200 nm and about 250 nm. In these various embodiments, light source 105 itself may be selected or adjusted to transmit a particular wavelength range of light in higher intensity, i.e., have the property of being tunable, for instance by employing a pressurized mercury lamp as a light source whose wavelength output and intensities at selected wavelengths vary as desired with a change of either pressure, operating temperature, applied voltage, modulated current, or a combination thereof. Mercury lamps are suitable for use in some embodiments owing to the high spectral intensity at discrete wavelengths of interest that said lamps generate. However, other sources of UV radiation are suitable for use and include, but are not limited to, xenon arc lamps (commonly used as sunlight simulators), deuterium arc lamps, mercury-xenon arc lamps, metal-halide arc lamps, and tungsten-halogen incandescent lamps. More recently, other sources of UV radiation that can also be employed include solid-state emitting devices including, but not limited to, light emitting diodes (LEDs), excimer light sources and laser light emitting photodiodes (LEPs). One aspect of most suitable light sources for use in the invention is the generation of other wavelengths of light (visible, near infrared) and heat radiation (near and far infrared) that is most desirably not directed toward the medium treatment tube, so as not to produce undesired heating or other photo-absorption events. Accordingly, other means of absorbing, blocking and/or redirecting those undesirable wavelengths or portions of the light source emission so as to prevent their interaction with the medium within the medium transport tube 145 is desirable, various embodiments of such means being described herein.

Depending on the desired wavelength of the light source 105 desired, one may employ a combination of a source of irradiation as described above and a combination of means to absorb, block and/or redirect those portions or wavelengths of the source of irradiation that are desired to be excluded from the light actually reaching or being directed onto the medium transport tube 145.

Choice of the wavelength of the light source is made depending on the desired mode of operation for some embodiments, which can be adjusted or selected to irradiate into either one or more absorption bands exhibited by molecular oxygen (O₂), or into either one or more absorption bands exhibited by ozone (O₃). As seen in FIG. 5, the two molecular species of oxygen have distinct absorption bands with different maximum absorbance peaks over the 150 nm to 350 nm range. Molecular oxygen, being a molecular with a ground state electron spin triplet electronic configuration, has a multiple number of possible transitions that result in an absorption maximum that occurs below around 200 nm, represented in FIG. 5 in the left trace in the plot of absorption intensity (arbitrary scale on Y axis) versus absorption wavelength (nm) along the X axis. In some embodiments of the invention, it is desirable to excite into the oxygen absorption band by limiting the light source radiation reaching the medium transport tube to wavelengths of UV light at or below about 225 nm, or alternatively at or below about 200 nm, in order to avoid exciting into the absorption region of ozone. In further embodiments, it is further desirable to achieve the maximum excitation of molecular oxygen without exciting ozone that may be present or produced during irradiation of the medium or oxygen present therein, by selected a light source that can generate short UV wavelengths approaching the absorbance maximum of molecular oxygen, one such absorbance region being between 120 nm to about 250 nm, or alternatively between 120 nm to about 225 nm, or yet alternatively between 120 nm to about 200 nm, or alternatively between 120 nm to about 180 nm. In some embodiments, employing a light source or a means of controlling the incident radiation reaching the medium transport tube to wavelengths below about 180 nm, the medium can then be exposed to radiation that will only excite into the molecular oxygen band. In these embodiments, either the source of light or some filtering means, such as for example but not limited to one or a plurality of gratings, bandpass filters, cutoff filters or combinations thereof, may act to limit the transmittal and the subsequent absorption of undesired wavelengths of light by ozone that is present or generated within the transport tube, thus minimizing the loss of ozone via light-induced decomposition of ozone, and therefore preserving the level of ozone present within the medium. Higher ozone levels maintained within the medium then act to effect a greater and/or faster transformation of the medium, increasing the effectiveness of the invention in treating a gaseous or liquid medium. In some embodiments of the invention, it is desired to generate the maximum amount of radical oxygen species such as singlet oxygen (O⋅), which is one of the desired reactive species that serves as a means to crosslink tannins, flavonoids and other oxygen-mediated or photochemically-susceptible materials present in a medium that has materials present that are desired to be treated, transformed, cross-linked, deactivated, or otherwise chemically modified by action of an excited oxygen species or reaction product thereof for the purpose of modifying the medium undergoing the irradiation process.

Accordingly, in an improved process for the irradiation of a medium, one embodiment may employ a light source emitting a desired range of ultraviolet wavelengths in combination with one or more means of modifying the emitting wavelengths to select those desired wavelengths and direct them onto the medium transport tube in order to generate the desired excited oxygen species or reaction product thereof that serves to chemically modify the treated medium. For example, in one embodiment in which the medium has tannins present, such as wine, the selection of a low ultraviolet emitting light source capable of producing high intensity output of light having wavelengths between 120 nm to 180 nm is suitable to induce the photochemical reaction shown in FIG. 4 in which two tannin molecules present in the medium to be treated by the irradiation become chemically cross-linked to form a dimer molecule having different properties than the single tannin molecules originally present. In other embodiments, additional ultraviolet light having wavelengths of 260-300 nm may be selected during irradiation of the medium for exciting tannins and flavonoids.

Thus, in related embodiments, the level of tannins, flavonoids and other similar chemical compounds that can be photochemically crosslinked or modified, may easily be controlled or modified by irradiation, the extent of such modification depending on the light source intensity, wavelength, efficiency of interaction with the medium present in the medium transport tube, as well as other factors such as flow rate, cycle time, number of treatment cycles, and other parameters as disclosed therein. With respect to tannins, the cross-linked tannins, following the method of irradiation of a medium as disclosed herein, have poorer solubility in the solvent comprising the medium (i.e., water and alcohol) and thus tend to precipitate out of solution, resulting in an altered or improved flavor. In other embodiments of the invention, the method of irradiation can be used to modify the flavor, taste, smell, aroma, tartness, bitterness, sweetness and/or other oral or olfactory characteristics of the medium being treated from an initial untreated state to a preferred post-treatment state. Further, in other embodiments, the inventive method can be modified to exhibit little or no direct effect on the medium chemistry, other than providing the advantage of sterilizing or destroying microbial entities present in the medium that are susceptible to irradiation, such as for example, but not limited to, the destruction or reduction in population of archeons, biologicals, bacteria, mildew, mold, prions, microbes and viruses. In yet further embodiments, the device may be configured to deliver radiation in order to effect a desired chemical change as well as sterilization of the medium, as desired.

Without being bound by theory, it is believed that the wavelengths of UV light between 120 nm and about 200 nm are particularly useful for the treatment of selected mediums having photochemically susceptible species present owing to the large number of activated or excited oxygen species (O2, and its ions O2−, O2+, O22+) that effectively absorb radiation within this range, as reported by Dr. Paul H. Krupenie, Optical Physics Division, National Bureau of Standards, Washington, D.C., 20234 as reported in his review titled “The Spectrum of Molecular Oxygen,” published in 1972, and referenced as J. Phys. Chem. Ref. Data, Vol. 2, No. 2, 1972 in the Journal of Physical Chemistry, which is incorporated in its entirety herein by reference. An additional advantage of the inventive method described herein employing the range of vacuum-UV wavelengths below 200 nm is that absorption by other species of oxygen (such as ozone) and other chemical materials present in the medium is avoided, enabling greater penetration of the irradiation into the medium for more effective interaction, as well as in the reduction of other unwanted photochemical events otherwise produced by ultraviolet light if present at wavelengths above 200 nm.

In this manner, using embodiments described herein, oxygen excitation in the range of 160-260 nm may occur in combination with the excitation of the flavonoids in the range 270-290 nm and may thereby condense monomers to form dimers, trimers, etc.

### Graph 520: Color Intensity Changes

FIG. 5A also illustrates changes in color intensity of various wines after treatment by embodiments described herein. Graph 520 shows the influence of oxygen on the color of red wine during treatment by embodiments described herein. Color intensity is shown on the Y-axis and treatment time is shown on the X-axis. In graph 520, both +O₂ at 9 parts per million and −O₂ at nearly 0 parts per million are shown. As shown, the error bars show an interval of confidence 90%. In one test, the treatment process was repeated three times and samples were measured at wavelengths of 420+520+620 nm.

### FIG. 5B: Graph 540 and 560: Oxygen Concentration Changes

FIG. 5B illustrates oxygen concentration with and without the use of embodiments described herein. Graph 540 shows oxygen concentration in milligrams per liter (Y-axis) versus treatment time in minutes (X-axis) without the use of embodiments described herein on various wines.

Graph 560 shows oxygen concentration in milligrams per liter (Y-axis) versus treatment time in minutes (X-axis) with the use of embodiments described herein on various wines. Graphs 540 and 560 include the following wines: a 2012 Redwine Cuvee, a 2012 Pinot Noir and a 2010 Duro Niepoort Fabelhaft.

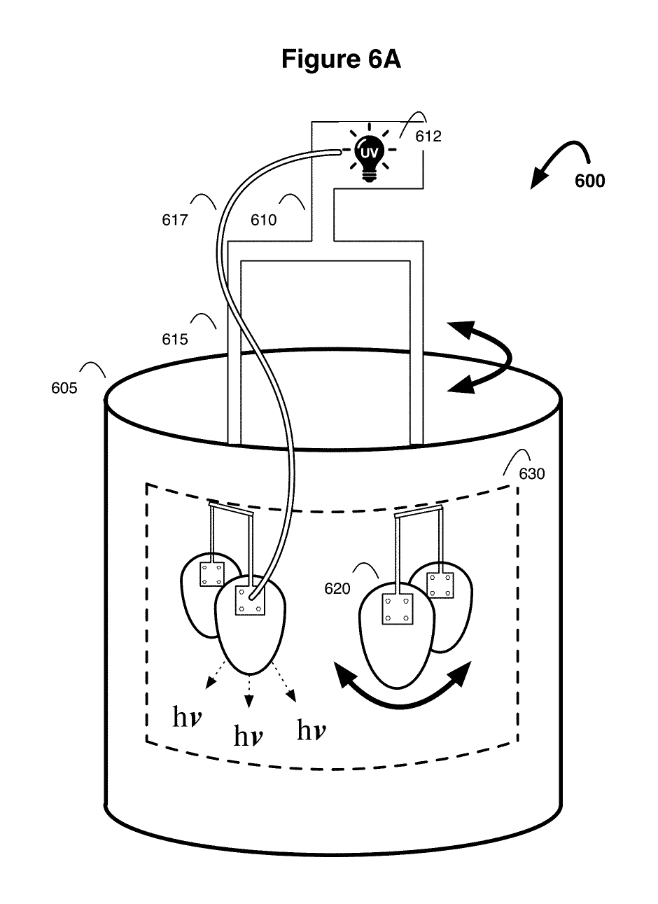

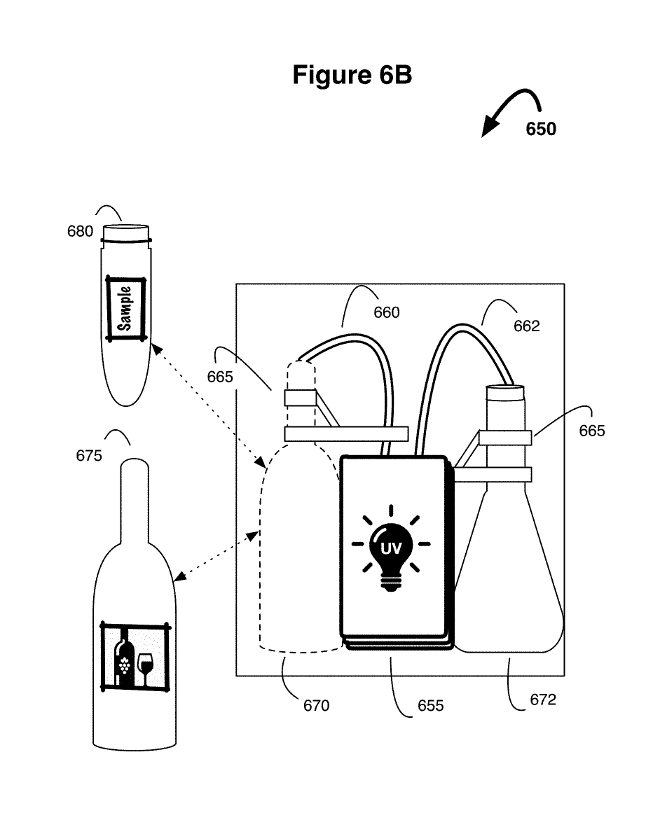

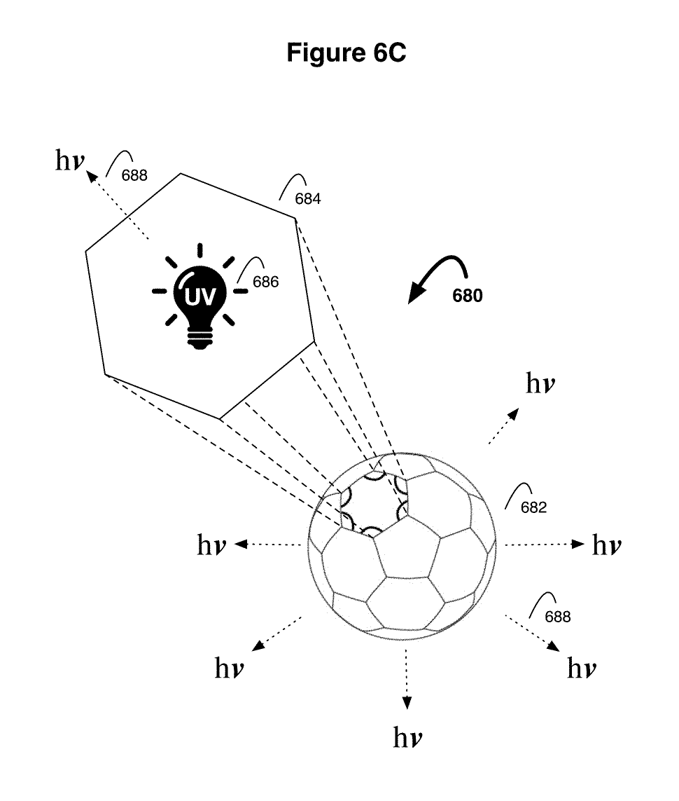

### FIGS. 6A, 6B and 6C: Alternative Embodiments

FIG. 6A: agitator-diffuser system

FIGS. 6A, 6B and 6C illustrate alternative indirect irradiation systems, according to embodiments of the disclosure. FIG. 6A illustrates agitator-diffuser system 600 which includes treatment tank 605, combination axle and fiber optic 610, combination rotor and fiber optic 615, and combination light diffuser and agitator 620. Fiber optic 615 may be fed by light source 612. While light source 612 is shown as a UV light bulb, the inventor contemplates the use of any wavelength as described herein to be used.

Some elements that might otherwise be obscured by tank 605 are made visible for the viewer's benefit through cutaway 630. A motor (not shown) drives combination axle and fiber optic 610 to rotate. The rotation of combination axle and fiber optic 610 supplies rotational locomotion of combination rotor and fiber optic 615, which in turn supplies rotational locomotion of combination light diffuser and agitator 620, which in turn causes turbulence within the contents of tank 605. In some embodiments, tank 605 may contain liquid or gaseous mediums such as wine, olive oil, milk or other products to be irradiated.

Axle 620 is attached to or contains fiber optic cable 617. By way of example and not limitation, fiber optic 617 is illustrated as exterior in FIG. 6A, but may also be contained within or proximate to axle 620, and may include a freely-rotating light junction (not shown) to allow for slippage of the fiber optics during agitation of the medium. Fiber optic cable 617 allows for transport of light (e.g., vacuum UV) to combination rotor and light diffuser 615, which may also contains a fiber optic cable that allows for transport of light to combination light diffuser and agitator 620. In this manner, combination light diffuser and agitator 620 irradiate the contents of tank 605 while simultaneously causing turbulence of the contents of tank 605. In this manner, the contents of tank 605 may be more uniformly irradiated (as shown by photons hν). In some embodiments, agitator-diffuser system 600 may be suitable for small quantities of medium to be treated. In other embodiments, agitator-diffuser system 600 may employ freely rotating sheathing for the fiber optics or a freely-rotating light junction connecting one or more fiber optics in order to allow slippage of the fiber optics during agitation of the medium.

In another embodiment, fiber optics emitting UV light may be directly inserted (not shown) into content medium to allow for close-proximity irradiation of content medium. In further embodiments, these fiber optics may be swept through the content medium to allow for approximately uniform irradiation.

### FIG. 6B: Bench-top System

FIG. 6B illustrates a bench-top indirect irradiation system (bench-top system 650), according to embodiments of the disclosure. In some embodiments, bench-top system 650 may be miniaturized for use on a table top. Bench-top system 650 includes indirect irradiator 655, inflow tube 660, outflow tube 662, securement means 665, placement area 670, output container 672, optional bottle 675 and optional test tube 680. Indirect irradiator 655 includes an optical system (not shown) as described herein. In some embodiments, indirect irradiator 655 may also include one or more pumps (not shown) as described herein.

In one embodiment, inflow tube 660 may be used to transfer medium contents from a container into indirect irradiator 655 for irradiation. Securement means 665 may be used to secure a container (e.g., optional bottle 675 or optional test tube 680) in place for exposure to indirect irradiator 655, as well as secure an output container 672. While securement means 665 is illustrated as a retort stand and clamp, the inventor contemplates any and all known means of securing a container.

Placement area 670 is a guideline to show where a container with medium contents can be placed, and is shown as a dashed outline. It should be noted that, while placement area 670 is shown as a dashed outline of a wine bottle, the inventor contemplates all shapes of placement areas 670 that could allow for exposure by indirect irradiator 655.

Optional bottle 675 and optional test tube 680 are exemplary containers for continuing medium contents to be treated. While optional bottle 675 is shown in the exemplary shape of a wine bottle, and optional test tube 680 is shown in the exemplary shape of a test tube, the inventor contemplates any and all known container shapes. Furthermore, optional bottle 675 and test tube 680 may be made of any material mentioned herein and the inventor further contemplates using any known material. In some embodiments, the container material (e.g., optional bottle 675 and test tube 680) may be made of quartz or a material that minimally impinges on the indirect irradiation process as described herein.

In one embodiment, indirect irradiation system 655 may take the form of a transportable, bench-top instrument as illustrated. In a further embodiment, indirect irradiation system 655 may include an optical system as described herein. In one embodiment, indirect irradiator 655 may irradiate medium contents stored in, by way of example and not limitation, bottle 675 when bottle 675 is placed in placement area 670.

In this example, indirect irradiator 655 may irradiate medium contents in bottle 675 without the need for inflow tube 660. This is represented by indirect irradiator 655 partially obscuring placement area 670. In this manner, inflow tube 660 may not be inserted into or otherwise attached to a container (e.g., bottle 675). In this manner, a precise amount of medium contents may be irradiated for later testing. Further in this manner, a container may be pre-loaded with medium contents, irradiated, and then removed without loss of medium contents to tubing, pumps etc., which may be useful when precise quantities of medium contents are required. For example, medium contents stored in test tube 680 may be treated by indirect irradiator 655 and then removed. In these examples, at least part of the container wall allows for at least partial penetration of UV light at wavelengths as described herein.

In another embodiment, a peristaltic pump (not shown) may be used to pump medium contents from a container (e.g., bottle 675 or test tube 680) into an optical system for indirect irradiation exposure by indirect irradiator 655 through inflow tube 660. In this example, a peristaltic pump may be included in or placed proximity to bench-top system 650 in order to supply medium contents from a container to indirect irradiator 655, and then transfer medium contents after irradiation through outflow tube 662 into output container 672.

### FIG. 6C: Self-Contained Deployment System

FIG. 6C illustrates a system for deploying an indirect irradiation system in a self-contained unit in a medium container. In one embodiment, embodiments described herein may be placed into a vat (not shown), which is then closed. Embodiments described herein may be remote activated or activated by wire through the tank to allow treatment to begin. By way of example and not limitation, embodiments described herein may be deployed in a wine vat and left in wine to begin the irradiation process of polymerizing tannins as described herein.

Self-contained deployment system 680 includes self-contained unit 682. Self-contained unit 682 is illustrated, by way of example and not limitation, as an approximate sphere composed of hexagonal and pentagonal panels, however, the inventor contemplates any and all shapes. Self-contained unit 682 is illustrated with one hexagonal panel (panel 684) removed for clarity. Within self-contained unit 682, a UV light source and other embodiments described herein may be contained. Power to self-contained unit 682 may be provided by batteries, induction or an external cable (not shown) as known. Self-contained unit 682 may include a full indirect irradiation system (not shown) as described herein. Self- contained unit 682 may include computer control elements (not shown) as described herein. Instructions may be provided to self-contained unit 682 by wire or remote as known. The inventor envisions the deployment of multiple self-contained unit 682 as needed (e.g., depending on the medium container size or total medium contents to be treated).

Panel 684 shields light source 686. Panel 684 may be any material as described herein including quartz, synthetic quartz, phopshored material, or any material that allows for wavelengths as described herein to reach medium to be treated (e.g., wine).

(100) Light source 686 is shown, by way of example and not limitation as a UV bulb, however, the inventor contemplates the use of any wavelength as described herein. Light waves 688 emanate from self-contained unit 682 as shown, and may take the form of UV light as described herein. In this manner, contents may be uniformly irradiated (as shown by photons hν).

In other embodiments, self-contained unit 682 may include a reinforced shell of panels similar to panel 684. In a further embodiment, self-contained unit 682 may include a quartz shell reinforced with stainless steel seams. In some embodiments, self-contained unit 682 may be sterilized before use.

Additional information can be found in the appendix attached to this disclosure which is included by reference to this specification. The appendix includes results of testing and other operations from one or more embodiments disclosed herein and should be read in a non-limiting manner.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

I claim:

1. An apparatus for the indirect electromagnetic irradiation of a liquid or gaseous medium comprising:
a. an ultraviolet light source;
b. a medium transport tube that is transparent or capable of transmitting selected electromagnetic wavelengths emitted by said ultraviolet light source; wherein said selected electromagnetic wavelengths of ultraviolet light are between 120 nm to 300 nm, or alternatively between 120 nm to 225 nm, or alternatively between 120 nm to 200 nm, or alternatively between 120 nm to 180 nm, or alternatively between 160 and 300 nm;
c. a medium consisting of a liquid or gaseous material flowable through said medium transport tube;
d. a means of transporting said liquid or gaseous material through said medium transport tube selected from a gravity feed system, pump, rotor, peristaltic pump, membrane pump, gravity pump, low pressure or vacuum inductor, or combination thereof;
e. a means of redirecting said selected electromagnetic wavelengths emitted by said ultraviolet light source into the medium within said medium transport tube selected from a parabolic mirror, flat mirror, grating, prism, bandpass filter, cutoff filter, dichroic mirror, phosphored mirror, and combinations thereof; and
f. a control module that provides a means of controlling the intensity of said ultraviolet light source as well as the exposure time and rate of flow of said medium through said medium transport tube.

2. A method of treating a flowable medium, said method comprising the steps of:
loading a medium from a pretreatment container into a transport tube, wherein the transport tube is composed of a UV-transparent material;
exposing the medium in the transport tube to ultraviolet light from an ultraviolet light source for a predetermined amount of time; and
unloading the medium into a posttreatment container.

3. The method of claim 2 above, wherein the predetermined time may be related to the amount of medium.

4. The method of claim 2 above, wherein the predetermined time may be related to the type of medium.

5. The method of claim 2 above, wherein the loading process is approximately continuous and approximately incremental in the form of a flowing medium.

6. The method of claim 2 above, wherein the exposure of the medium irradiates approximately uniform across the medium.

7. The method of claim 2 above, wherein the irradiation of the medium occurs for an approximately equal amount of time across the medium.

8. The method of claim 2 above, wherein the wavelength of the ultraviolet light irradiating the medium is approximately 265 nanometers.

9. The method of claim 2 above, wherein the medium is one of wine, alcoholic spirits, milk or olive oil.

10. Wine produced according to the process of claim 9, above.

11. A device for the indirect electromagnetic irradiation of a liquid or gaseous medium comprising:
a treatment tube;
a light source;
one or more mirrors;
a pump;
a medium to be treated; and
a control module.
